(19) United States
(12) Patent Application Publication
(10) Pub. No.: US 2019/0225239 A1
(43) Pub. Date: Jul. 25, 2019

(54) DISPLAY DEVICE FOR A VEHICLE AND VEHICLE

(71) Applicant: Toyota Jidosha Kabushiki Kaisha, Toyota-shi Aichi-ken (JP)

(72) Inventors: Akira Sasaki, Miyoshi-shi Aichi-ken (JP); Eisuke Ando, Nagoya-shi Aichi-ken (JP); Misako Hayashima, Okazaki-shi Aichi-ken (JP); Saki Kitoh, Okazaki-shi Aichi-ken (JP); Masahiro Yamashita, Seto-shi Aichi-ken (JP)

(21) Appl. No.: 16/254,066

(22) Filed: Jan. 22, 2019

(30) Foreign Application Priority Data
Jan. 24, 2018 (JP) 2018-009742

(51) Int. Cl. B60W 50/14; B60K 35/00; G05D 1/00; G01C 21/36

(52) U.S. Cl. CPC B60W 50/14; B60K 35/00; G05D 1/0061; B60K 2350/1076; B60W 2050/146; B60K 2350/106; G01C 21/3697

(57) ABSTRACT

A display device for a vehicle includes: a display unit; a section setting unit that divides a travel route into at least one automated driving recommended section where the vehicle travels in automated driving mode, and at least one manual driving recommended sections where traveling in manual driving mode is urged; and a display control unit that, when a vehicle is traveling in automated driving mode in the at least one automated driving recommended section, displays on the display unit at least one first video image that is able to relax a level of alertness of a vehicle occupant when viewed by the vehicle occupant, and before the vehicle reaches the at least one manual driving recommended section, displays on the display unit a second video image that promotes an increased level of alertness in the vehicle occupant when viewed by the vehicle occupant.

### CROSS-REFERENCE TO RELATED APPLICATION

This application is based on and claims priority under 35 USC 119 from Japanese Patent Application No. 2018-009742 filed on Jan. 24, 2018, the disclosure of which is incorporated by reference herein.

### BACKGROUND

### Technical Field

The present disclosure relates to a display device for a vehicle, and to a vehicle.

### Related Art

A vehicle that is capable of traveling in automated driving mode travels on a predetermined travel course while steering control, speed control, and braking control of the vehicle are performed by a control device. The vehicle switches from automated driving mode to manual driving mode as a result of a vehicle occupant beginning a driving operation.

Here, a driving switching device has been proposed that, when it is determined based on environmental information relating to the vehicle surroundings such as the road conditions, and based on information relating to the movements of its own host vehicle that automated driving of the host vehicle should end, informs the vehicle occupant that they should switch from automated driving to manual driving, and switches from automated driving to manual driving as a result of the vehicle occupant performing a switching operation (see, for example, Japanese Patent Application Laid-open (JP-A) No. 2017-154542).

Further, an automated driving support system has been proposed in which switching recommended geographical points where switching from automated driving to manual driving is recommended are set on a road on which a vehicle is traveling, and at these set switching recommended geographical points, a vehicle occupant is urged to switch from automated driving to manual driving (see, for example, JP-A No. 2017-165411).

A traveling state presentation device has also been proposed in JP-A No. 2001-199295 that determines a degree of stability of automated driving control by recognizing the environment surrounding a vehicle, and by then displaying images that correspond to this degree of stability on a display unit, enables a driver to judge the likelihood that it will become necessary to switch from automated driving to manual driving, and thereby enables the driver to prepare their mental attitude and driving posture for performing manual driving.

It is, of course, desirable that a vehicle occupant is in a suitable state of alertness for performing a driving operation when the vehicle is in manual driving mode, however, if the vehicle occupant continues to remain in this state of alertness, there is a risk of fatigue accumulating in the vehicle occupant. Because of this, when a vehicle is traveling in automated driving mode, it is desirable that the state of alertness of the vehicle occupant be relaxed so that the vehicle occupant is able to recover from their fatigue. Moreover, when switching from automated driving mode to manual driving mode, it is useful that the vehicle occupant is in a suitable state of alertness for performing a driving operation, and there is further room for improvement from the standpoint of improving the level of support that is given to a vehicle occupant.

### SUMMARY

The present disclosure has been conceived in view of the above-described circumstances, and provides a display device for a vehicle and a vehicle that are able to inhibit fatigue accumulating in a vehicle occupant, and enable the alertness of a vehicle occupant to be raised to a suitable level for performing a driving operation during manual driving.

A first aspect of the present disclosure is a display device for a vehicle including a display unit; a section setting unit that divides a travel route traveled by a vehicle into at least one automated driving recommended section where the vehicle travels in automated driving mode, and at least one manual driving recommended sections where traveling in manual driving mode is urged; and a display control unit that, when a vehicle is traveling in automated driving mode in the at least one automated driving recommended section, displays on the display unit at least one first video image that is able to relax a level of alertness of a vehicle occupant when the vehicle occupant views the at least one first video image, and before the vehicle reaches the at least one manual driving recommended section, displays on the display unit a second video image that promotes an increased level of alertness in the vehicle occupant when the vehicle occupant views the second video image.

In the display device for a vehicle of the first aspect, a section setting unit divides a travel route into automated driving recommended sections where a vehicle travels in automated driving mode, and manual driving recommended sections where traveling in manual driving mode is encouraged. As a result, a vehicle is able to travel is automated driving mode in automated driving recommended sections, and is able to switch between traveling in automated driving mode and traveling in manual driving mode at manual driving recommended sections.

Here, a Bouba/Kiki effect is present not only in picture images, but there are also some video images that may generate a calm feeling in a viewer so that an effect of relaxing the level of alertness of that viewer is obtained, while other video images may conversely increase the level of alertness in the viewer. A display control unit displays on a display unit first video images that are able to relax the level of alertness in a vehicle occupant when the vehicle occupant views these first video images, and second video images that promote an increased level of alertness in a vehicle occupant when the vehicle occupant views the second video images. The display control unit displays the first video images on the display unit when the vehicle is traveling through an automated driving recommended section in automated driving mode, and displays the second video images on the display unit before the vehicle reaches a manual driving recommended section.

As a result, because the vehicle travels through an automated driving recommended section in automated driving mode, the state of alertness of a vehicle occupant may be relaxed, so that the vehicle occupant is able to recover from their fatigue. Additionally, because the vehicle occupant views the second video images after the first video images, the level of alertness of the vehicle occupant that had been relaxed by the first video images is able to be heightened, and when the vehicle occupant is performing a driving operation in a manual driving recommended section, the level of alertness of the vehicle occupant is raised to a suitable state.

In the first aspect, the display control unit may set at least one of the at least one first video image or the second video image in accordance with preference information for the vehicle occupant.

In the above-described structure, at least one of the first video images or the second video images are set in accordance with the preferences of the vehicle occupant and are displayed on the display unit. The vehicle occupant is able to improve the effect of the video images on their state of alertness by viewing video images that match their own preferences.

The first aspect may further include a receiving unit that receives inputs of the at least one manual driving recommended section relating to the travel route, and the section setting unit may set sections received by the receiving unit as the at least one manual driving recommended section.

In the above-described structure, the receiving unit receives inputs of manual driving recommended sections from a vehicle occupant. As a result, a vehicle occupant is able to set manual driving recommended sections according to their own preferences. Because the vehicle occupant is then able to enjoy performing a driving operation in the manual driving recommended sections, it is possible to inhibit a feeling of fatigue from being generated in the vehicle occupant.

In the first aspect, the at least one first video images may be a video image having a blue-based color tone, and the second video image may be a video image having a red-based color tone.

In the above-described structure, the color tone of the first video images is blue-based, while the color tone of the second video images is red-based. By using video images having a blue-based color tone for the first video images, the state of alertness of a vehicle occupant may be effectively relaxed, and by using video images having a red-based color tone for the second video images, the relaxed state of alertness of a vehicle occupant may be effectively heightened.

In the first aspect, the display control unit may display a third video image, which is an intermediate video image midway between the at least one first video image and the second video image, on the display unit between the at least one first video image and the second video image.

In the above-described structure, third video images, which are intermediate video images, are displayed on the display unit between the first video images and the second video images. For example, if the first video images have a blue-based color tone, and the second video images have a red-based color tone, then video images having a yellow-based color tone may be used for the third video images. As a result, when the display is changing from the first video images to the second video images, it is possible to prevent the vehicle occupant from being overly stimulated, and to thereby prevent the emotional state of the vehicle occupant from becoming over-burdened.

A second aspect of the present disclosure is a vehicle provided with the display device for a vehicle according to the first aspect.

In the vehicle according to the second aspect, by providing a display device for a vehicle that displays first video images and second video images in automated driving recommended sections, a recovery in the level of fatigue of a vehicle occupant may be achieved, and the vehicle occupant is able to perform an appropriate driving operation when in manual driving mode.

As has been described above, according to the present disclosure, the level of alertness of a vehicle occupant may be relaxed and the recovery in the level of fatigue of the vehicle occupant may be hastened when a vehicle is traveling in an automated driving mode, and when the vehicle switches to a manual driving mode, the level of alertness of the vehicle occupant may be raised to an appropriate state for performing a driving operation.

### BRIEF DESCRIPTION OF THE DRAWINGS

Exemplary embodiments of the present disclosure will be described in detail based on the following figures, wherein:

FIG. 1 is a schematic view as seen from an outer side in a vehicle width direction illustrating principal portions of a vehicle according to an exemplary embodiment;

FIG. 2 is a schematic view illustrating a vehicle cabin front side as seen from a vehicle cabin interior;

FIG. 3 is a block diagram illustrating the schematic structure of a display device according to an exemplary embodiment;

FIG. 4 is a schematic view illustrating an example of a travel route displayed on a monitor;

FIG. 5 is a flowchart illustrating an outline of travel route setting processing; and

FIG. 6 is a flowchart illustrating an outline of display processing performed using a monitor.

### DETAILED DESCRIPTION

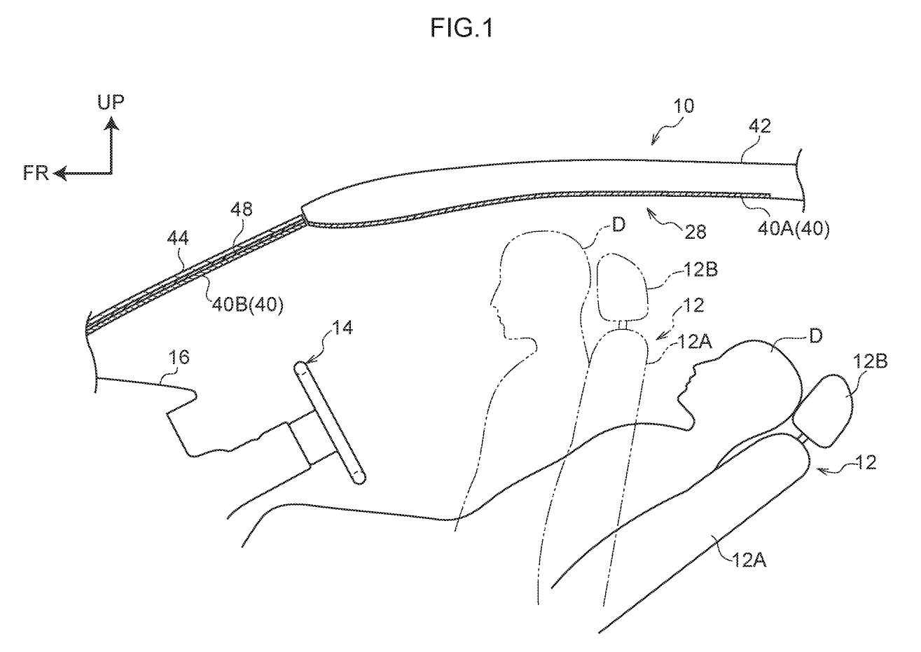

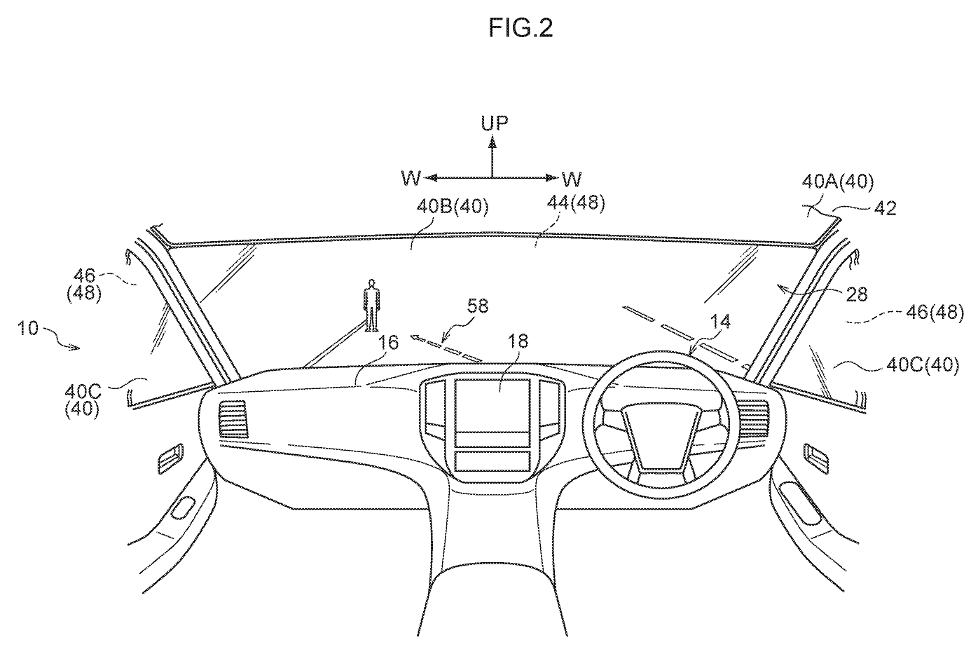

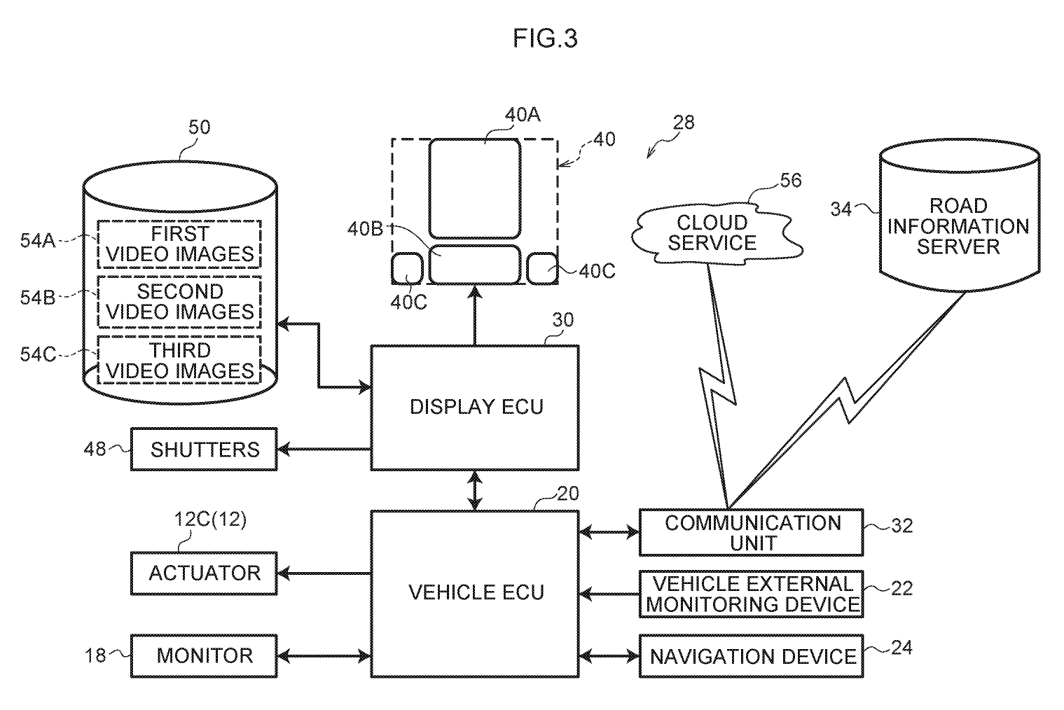

Principal portions of a vehicle 10 according to an exemplary embodiment are illustrated in a schematic view as seen from an outer side in a vehicle width direction in FIG. 1, while a vehicle front side of a vehicle cabin interior is illustrated in a schematic view in FIG. 2, and principal portions of a control unit provided in the vehicle 10 are illustrated in a block diagram in FIG. 3. Note that an arrow FR, an arrow UP, and an arrow W that are illustrated in the drawings respectively indicate a vehicle forward direction, a vehicle upward direction, and a vehicle width direction.

As is illustrated in FIG. 1, a seat 12 on which a vehicle occupant (i.e., a driver D) sits is provided in the vehicle 10, and the seat 12 includes a seat cushion (not illustrated in the drawings) on which the driver D sits, a seatback 12A that supports a back portion of the driver D, and a headrest 12B that supports a head portion of the driver D. A lower end portion of the seatback 12A of the seat 12 is able to pivot relative to the seat cushion around a shaft portion (not illustrated in the drawings) extending in the vehicle width direction that is disposed at a rear end portion of the seat cushion, so that the seat 12 is formed as a reclining seat. Additionally, an actuator 12C for reclining (see FIG. 3) is provided in the seat cushion of the seat 12.

In the seat 12, the seatback 12A is pivoted as a result of the actuator 12C being operated, and is tilted between an upright position (see the double-dot chain line in FIG. D in which the driver D is in a suitable posture for performing a driving operation, and a rearward tilted position (i.e., a reclining position; see the solid line in FIG. D in which the driver D is in a suitable posture for relaxing.

As is illustrated in FIG. 1 and FIG. 2, a steering wheel 14 that forms a vehicle steering device is provided in the vehicle 10. The steering wheel 14 is gripped by the driver D who is sitting in the seat 12 when the driver D is performing a driving operation to drive the vehicle 110, and is thereby used by the driver D to steer the vehicle 10.

As is illustrated in FIG. 2, a touch panel type of monitor 18 is provided as a receiving unit in an instrument panel 16 of the vehicle cabin front portion. Various types of information are displayed on the monitor 18 so as to be visible to the driver D, and the driver D is able to input various types of information via the monitor 18.

As is illustrated in FIG. 3, a vehicle ECU 20 is provided as a control unit that controls vehicle travel in the vehicle 10, and the vehicle 10 is thereby able to travel in a manual driving mode in which the driver D performs driving operations, and an automated driving mode in which the vehicle ECU 20 performs travel control. The vehicle ECU 20 includes memory and a processor such as a Central Processing Unit (CPU), and controls operations of various units that are electrically connected to the vehicle ECU 20. The vehicle ECU 20 switches from manual driving mode to automated driving mode, and from automated driving mode to manual driving mode based on requests from the driver D. Additionally, the vehicle ECU 20 urges the driver D to switch from automated driving mode to manual driving mode in accordance with the travel environment and road conditions, and switches from automated driving mode to manual driving mode when it is determined that a driving operation by the driver D to drive the vehicle 10 is possible.

The actuator 12C for reclining and the monitor 18 are electrically connected to the vehicle ECU 20, and the vehicle ECU 20 is able to control both operations of the actuator 12C and display on the monitor 18. Additionally, the vehicle ECU 20 performs control such that various types of information relating to vehicle travel and the like are displayed on the monitor 18. The vehicle ECU 20 displays a predetermined user interface (U/D on the monitor 18, and receives inputs of various types of information as a result of the driver D performing a touch operation on the screen of the monitor 18 in accordance with the displayed U/I.

A vehicle external monitoring device 22 that serves as a detecting unit to detect the travel environment and the like of its own host vehicle, and a navigation device 24 that serves as a route (i.e., section) setting unit are provided in the vehicle 10. The vehicle external monitoring device 22 and the navigation device 24 are electrically connected to the vehicle ECU 20.

The vehicle external monitoring device 22 is provided with multiple image capture units (not illustrated in the drawings) such as cameras or the like that capture images of an area around the vehicle 10 including the direction of travel (i.e., of the vehicle front side) of their own host vehicle, and with a measuring unit (not illustrated in the drawings) such as a millimeter-wave radar or an ultrasonic sonar or the like that measures distances between its own host vehicle and objects (such as other vehicles, objects, pedestrians and the like) around their own host vehicle. The vehicle external monitoring device 22 uses video images captured by the image capture units and measurement results from the measurement unit to analyze white lines that indicate traffic lanes and the like on the road surface, the traveling position of its own host vehicle on the road, objects around its own host vehicle, directions to such objects, relative directions of movement of such objects, distances to such objects, and relative speeds between its own host vehicle and such objects, and the like, and generates travel environment information when traveling in automated driving mode.

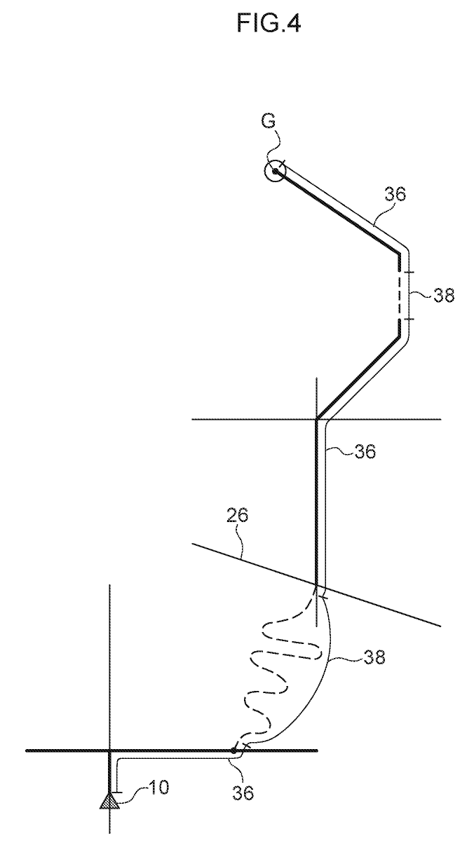

The navigation device 24 includes memory and a processor such as a Central Processing Unit (CPU). In addition to GPS (Global Positioning System) information, the navigation device 24 also acquires travel information such as the speed, acceleration, and travel distance and the like of its own host vehicle, and identifies the location and direction of travel of its own host vehicle based on the GPS information and travel information. An example of a travel route 26 that is set by the navigation device 24 and displayed on the monitor 18 is illustrated in FIG. 4.

Once the destination G has been set via an operation performed on the monitor 18, the navigation device 24 sets the travel route 26 as far as the destination G. As is illustrated in FIG. 4, the travel route 26 that is set in the navigation device 24 is displayed on the monitor 18 together with the position and direction of travel of the vehicle 10.

When the vehicle ECU 20 performs travel control of the vehicle 10 in automated driving mode, the vehicle ECU 20 causes the vehicle 10 to travel towards the destination G while performing steering control, speed control, and braking control of the vehicle 10 based on the travel environment information created by the vehicle external monitoring device 22 and on the travel route 26.

A display device 28 is provided as a display device for a vehicle in the vehicle 10, and this display device 28 is provided with a display ECU 30 that serves as a display control unit. The display ECU 30 includes memory and a processor such as a Central Processing Unit (CPU), and is electrically connected to the vehicle ECU 20. The display ECU 30 is electrically connected via the vehicle ECU 20 to each one of the actuator 12C, the monitor 18, the vehicle external monitoring device 22, and the navigation device 24.

A communication unit 32 is also provided in the vehicle 10, and the communication unit 32 is electrically connected via the ECU 20 to the navigation device 24. The communication unit 32 is capable of being connected to a road information server 34 via a wireless communication unit. Road information is stored in the road information server 34. The road information stored in the road information server 34 includes roadwork information, congestion information, road surface information and the like. The road surface information includes information such as whether or not obstacles that might affect vehicle travel such as sand or fallen trees are present on the road. The road information server 34 is able to acquire road information from other vehicles currently traveling, so that the road information contained in the road information server 34 is updated in real time.

The navigation device 24 acquires road information relating to the travel route 26 from the road information server 34 via the communication unit 32. Additionally, the navigation device 24 divides the travel route 26 into automated driving recommended sections 36 and manual driving recommended sections 38 based on road information acquired from the road information server 34. When the travel route 26 is being displayed on the monitor 18, the navigation device 24 distinctly indicates the automated driving recommended sections 36 and the manual driving recommended sections 38.

The automated driving recommended sections 36 are sections where the road conditions and the like are favorable for travel in automated driving mode. The automated driving recommended sections 36 include, for example, vehicle-only roads such as expressways, roads where non-vehicular traffic is minimal, and roads that have undergone structural improvements to make them suitable for travel in automated driving mode.

The manual driving recommended sections 38 are sections where travel in manual driving mode is favorable. These sections where travel in manual mode is favorable include sections where the road conditions are such that travel in automated driving mode would be difficult, and sections where the road conditions are such that it is predicted that it will be necessary to travel in manual driving mode. The manual driving recommended sections 38 include, for example, sections that have not undergone sufficient structural improvements to enable travel in automated driving mode, sections currently undergoing roadworks, and sections where obstacles such as sand or fallen trees are present on the road (including sections where the presence of such obstacles is predicted).

The manual driving recommended sections 38 may also include sections that have been set for the driver D to perform a driving operation. The setting of such manual driving recommended sections 38 by the driver D may be achieved, for example, by the driver D performing an operation to specify certain sections on the travel route 26 displayed on the monitor 18, and the navigation device 24 then setting these specified sections as the manual driving recommended sections 38. Additionally, the navigation device 24 may further divide the manual driving recommended sections 38 into sections in which it is predicted that travel in automated driving mode will be possible, and sections in which travel in manual driving mode is predicted (including sections in which there is a strong possibility that travel in automated driving mode will prove difficult, and sections that have been set as sections for the driver D to travel in manual driving mode).

In addition to sections where travel in manual driving mode is favorable, the manual driving mode recommended sections 38 also include sections necessary for performing the switch from automated driving mode to manual driving mode. These sections that are necessary for performing the switch from automated driving mode to manual driving mode are sections (i.e., distances) that it is predicted that the vehicle 10 will travel between the point when the vehicle ECU 20 requests that the driver D transition to manual driving mode and the point when the driver D actually switches to manual driving mode.

The vehicle ECU 20 causes the vehicle 10 to travel in automated driving mode in the automated driving mode recommended sections 36. Additionally, the vehicle ECU 20 controls the vehicle 10 so that it travels in automated driving mode in those sections of the manual driving mode recommended sections 38 where travel in automated driving mode is possible. Moreover, in those sections of the manual driving mode recommended sections 38 where it is determined that travel in automated driving mode will be difficult, the vehicle ECU 20 requests the driver D to transition to manual driving mode. As a result, the vehicle 10 is switched from traveling in automated driving mode to traveling in manual driving mode.

As is illustrated in FIG. 1 through FIG. 3, a monitor 40 is provided as a display unit in the display device 28 of the vehicle 10. A transparent organic EL panel which serves as a display medium is used for the monitor 40. The monitor 40 is divided into multiple monitors and, in the present exemplary embodiment, as an example, the monitor 40 is divided into monitors 40A. 40B, and 40C.

As is illustrated in FIG. 1 and FIG. 2, the monitor 40A is provided on a surface on the vehicle cabin interior side of a roof 42. The monitor 40B is provided on a surface on the vehicle cabin interior side of front windshield 44, and monitors 40C are provided respectively on surfaces on the vehicle cabin interior side of side window glass 46 on both sides in the vehicle width direction. As a result, by pivoting the seatback 12A of the seat 12 to the rearward tilted position, the driver D who is seated in the seat 12 is able to view display images on the monitors 40A through 40C. Moreover, by pivoting the seatback 12A of the seat 12 to the upright position, the driver D who is seated in the seat 12 is able to view display images on the monitors 403 and 40C, but not the monitor 40A. Note that it is also possible for the monitor 40 to be divided into even more monitors, and for these to be provided on other interior surfaces of the vehicle cabin such as side door trims (i.e., door trims) of the vehicle 10.

As is illustrated in FIG. 1, shutters 48 are provided as light-shielding components in the display device 28. The shutters 48 are disposed between the monitor 40B and the front windshield 44, and between the monitors 40C and each side window glass 46. Note that the shutters 48 between the monitors 40C and each side window glass 46 are not illustrated in the drawings. In some embodiments, a shutter 48 may be provided in other windshield glass that provides a partition between the vehicle cabin interior and the vehicle exterior such as the rear windshield.

Liquid crystal sheets, for example, are used for the shutters 48. These shutters 48 are formed as sheet-shaped liquid crystal panels in which the direction of alignment of the liquid crystal molecules differs depending on whether they are being operated as a result of voltage being applied thereto, or whether no voltage is being applied thereto. When the shutters 48 are operated by being supplied with voltage, they place the front windshield 44 and each side window glass 46 in a non-transparent state (i.e., in a light-shielded state). When voltage is not applied to the shutters 48 so that the operation thereof is halted, the front windshield 44 and each side window glass 46 are placed in a transparent state (i.e., in a non-light-shielded state). The vehicle cabin interior is light-shielded when the shutters 48 are operated, so that any intrusion of external light into the vehicle cabin interior is inhibited, and visibility of the vehicle cabin interior from outside the vehicle is also inhibited.

In the vehicle 10, as a result of the front windshield 44 and each side window glass 46 being placed in a light-shielded state, display images on the monitors 40B and 40C are made visible to the driver D. Further, as a result of the front windshield 44 and each side window glass 46 being placed in a non-light-shielded state, display images on the monitors 40B and 40C appear to the driver D as if superimposed on scenery outside the vehicle which may be seen through the front windshield 44 and each side window glass 46.

As is illustrated in FIG. 3, the monitor 40 (i.e., the monitors 40A through 40C) and the shutters 48 are electrically connected to the display ECU 30, and the display ECU 30 controls operations of the shutters 48 and image displays on the monitor 40 (i.e., the monitors 40A through 40C).

A storage unit 50 in which video images (i.e., video image data) are stored is provided in the display device 28, and the storage unit 50 is electrically connected to the display ECU 30. An HDD or semiconductor memory or the like, which is serving as a non-volatile storage medium, is used for the storage unit 50, and multiple video images (i.e., sets of video image data) used for displaying on the monitor 40 are stored in the storage unit 50.

The display ECU 30 displays a video image (i.e., plays back the video image) stored in the storage unit 50 on the monitor 40 while the vehicle 10 is traveling in automated driving mode through the automated driving recommended sections 36. At this time, by dividing the video image into video images for display on the monitors 40A, 40B, and 40C, the display ECU 30 displays a single video image on the monitors 40A, 40B, and 40C. If sound is included in the video image, the display ECU 30 is also able to output that sound (i.e., to play the video image soundtrack) through speakers (not illustrated in the drawings).

Here, first video images 54A, second video images 54B, and third video images 54C are stored in the storage unit 50. The impression obtained from the video images differs for each of the first video images 54A, the second video images 54B, and the third video image 54C. The first video images 54A, the second video images 54B, and the third video images 54C are differentiated on the basis of at least one of the color tone of the video images, the motion of the video images (i.e., the motion of objects contained in the video images), and the shape of objects (i.e., the principal objects) contained in the video images.

In cases in which the video images are differentiated based on color tone, video images having a blue-based color tone are used for the first video images 54A, video images having a red-based color tone are used for the second video images 54B, and video images having a yellow-based color tone are used for the third video images 54C. In cases in which the video images are differentiated based on the motion of the video images (i.e., the motion of objects contained in the video images), video images having a comparatively slow motion such as video images of slowly passing scenery are used for the first video images 54A, while video images having a comparatively fast motion such as video images of sport are used for the second video images 54B. In cases in which the video images are differentiated based on the shape of objects contained in the video images, then video images containing smoothly rounded objects are used for the first video images 54A, while video images that do not contain smoothly rounded objects (such as, for example, jagged objects) are used for the second video images 54B. In cases in which the video images are differentiated based on the motion of the video images or on the shape of objects contained in the video images, intermediate video images between the first video images 54A and the second video images 54B are used for the third video images 54C.

From the standpoint of a Bouba/Kiki effect, the first video images 54A and the second video images 54B may be differentiated such that video images in which the impression obtained from the video images is felt to be ‘Bouba’ may be used for the first video images 54A, while video images in which the impression obtained from the video images is felt to be ‘Kiki’ may be used for the second video images 54B. Additionally, intermediate video images midway between ‘Bouba’ and ‘Kiki’ may be used for the third video images 54C.

Plural first video images 54A, second video images 54B, and third video images 54C may be stored in the storage unit 50, and video images selected by the driver D from among the stored video images may be used for display. The first video images 54A through the third video images 54C stored in the storage unit 50 may be acquired from a video image providing cloud service 56. In cases in which the video images are acquired from the cloud service 56, the display ECU 30 is connected to the cloud service 56 via the communication unit 32.

In cases in which video images are acquired from the cloud service 56, the display ECU 30 receives preference information from the driver D via the monitor 18 such as the genre of the video images, or keywords indicating the content of the video images, that are used to identify video images preferred by the driver D. The display ECU 30 then retrieves video images that match the preference information received from the driver D from the cloud service 56. The display ECU 30 sorts the video images retrieved on the basis of the preference information into the first video images 54A and the second video images 54B, and stores them in the storage unit 50. At this time, the display ECU 30 separates the retrieved video images into the first video images 54A and the second video images 54B based on the color tone thereof, on the motion of the video images, and on the objects (i.e., the principal objects) contained in the video images before storing them in the storage unit 50.

When selecting video images to display on the monitor 40 from among the multiple video images, the display ECU 30 displays lists on the monitor 18 for each of the first video images 54A through the third video images 54C, and receives the selections of the driver D on the displayed lists. In some embodiments, multiple video images are selected for the first video images 54A, and that a display sequence is set for the selected video images. The display ECU 30 may include the selection and sequence ranking of the video images in the preference information, and may use them when acquiring new video images.

When the vehicle 10 is traveling in automated driving mode through any one of the automated driving recommended sections 36, the display ECU 30 causes the shutters 48 to operate, and displays video images on the monitor 40. At this time, the display ECU 30 displays the multiple first video images 54A on the monitor 40 in the previously set sequence. Additionally, the display ECU 30 displays the second video image 54B on the monitor 40 as the vehicle 10 approaches a manual driving recommended section 38. When switching the video images displayed on the monitor 40 from the first video image 54A to the second video image 54B, the display ECU 30 displays the third video image 54C therebetween. In other words, when displaying the second video images 54B, the display ECU 30 displays the second video image 54B after having displayed the third video image 54C for a predetermined time.

Furthermore, when the vehicle 10 enters a manual driving recommended section, the display ECU 30 deactivates the light-shielded state of the shutters 48, and enables the area around the vehicle 10, including the vehicle forward direction, to be viewed from inside the vehicle cabin. Additionally, in a case in which the vehicle external monitoring device 22 detects an object that has a possibility of affecting the travel of its own host vehicle, the display ECU 30 performs a driving support operation such as displaying this object on the monitor 40 (i.e., the monitor 40B and the like) such that it is easily visible to the driver D.

Next, operation of the exemplary embodiment will be described.

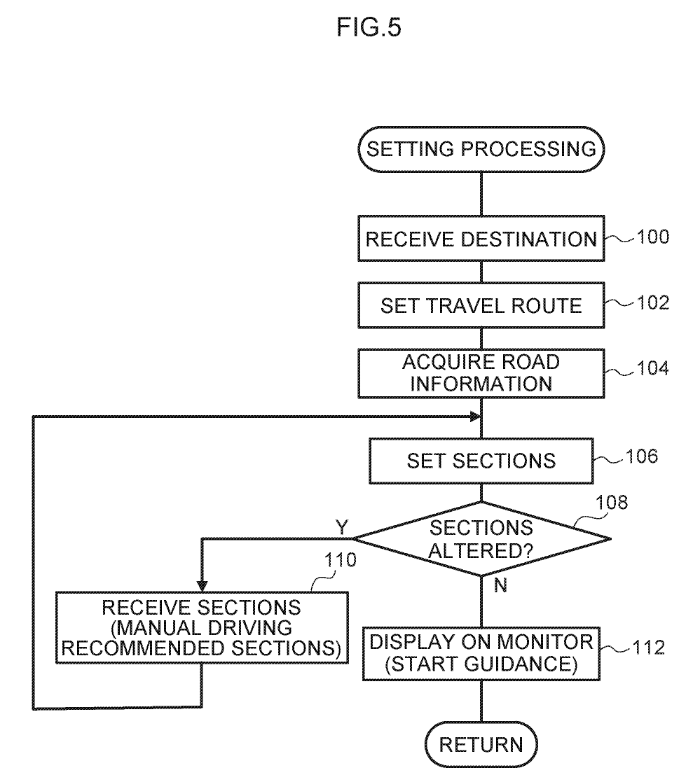

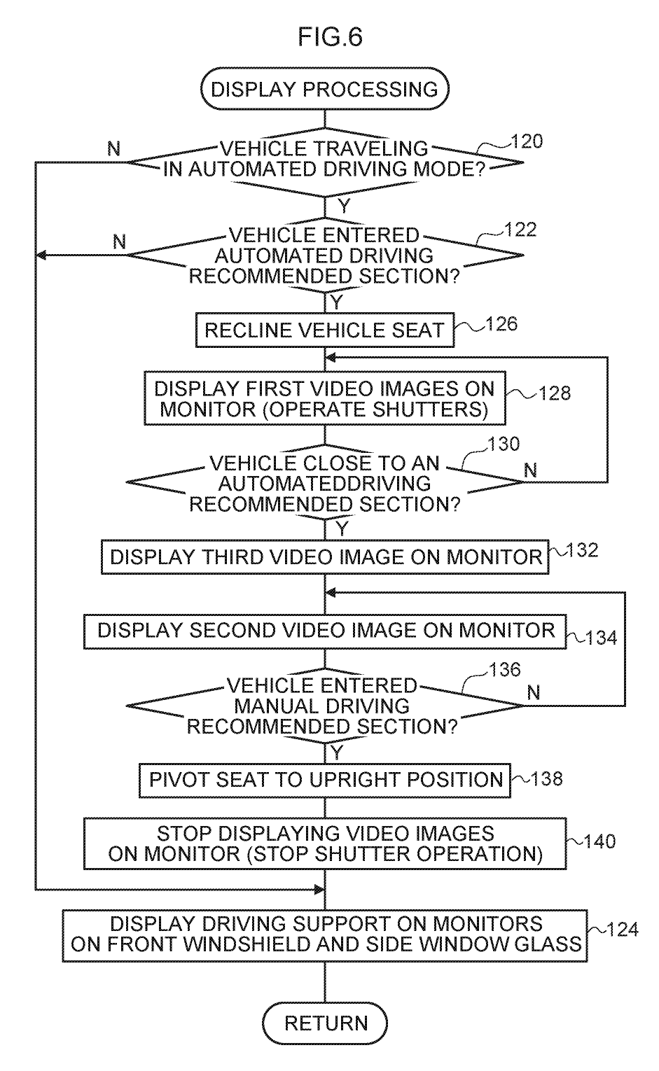

After the destination G has been specified and the travel route 26 has been set, the vehicle 10 may travel along the set travel route 26 either in automated driving mode or manual driving mode. An outline of the setting processing to set the travel route 26 that is executed by the navigation device 24 is illustrated in a flowchart in FIG. 5. The processing in the flowchart illustrated in FIG. 5 is performed, for example, by the CPU of the navigation device 24 loading a program that performs the setting processing on the memory, and executing this program. An outline of the display processing that is executed by the display ECU 30 and uses the monitor 40 is illustrated in a flowchart in FIG. 6. The processing in the flowchart illustrated in FIG. 6 is performed, for example, by the CPU of the display ECU 30 loading a program that performs the display processing on the memory, and executing this program.

In the flowchart illustrated in FIG. 5, firstly, in step 100, the setting of the destination G is received. The destination G is received via a touch operation performed on the monitor 18, and once the destination G has been received the routine moves to step 102. In step 102, the travel route 26 from the current location to the destination G is set.

In step 104, road information for the travel route 26 to the destination G is acquired from the road information server 34. In step 106, section set is performed based on the acquired road information. As a result, the travel route 26 is divided into automated driving recommended sections 36 and manual driving recommended sections 38. Thereafter, in step 108, whether or not any section alterations have been made to the set travel route 26, or to the divisions between the automated driving recommended sections 36 and manual driving recommended sections 38 along the travel route 26 is confirmed.

Here, for example, in a case in which a section is altered from an automated driving recommended section 36 to a manual driving recommended section 38 due to the driver D making an addition of manual driving recommended sections 38, then the determination in step 108 is affirmative, and the routine moves to step 110. In step 110, the altered section is received, and the automated driving recommended sections 36 and manual driving recommended sections 38 are set (i.e., step 106) with the received altered section included therein. In a case in which the travel route 26 to the destination G is altered, then the routine moves to step 102, and the resetting of the travel route 26, as well as the division thereof into the automated driving recommended sections 36 and manual driving recommended sections 38 are performed.

After completion of the setting of the travel route 26 to the destination G, and the setting of the automated driving recommended sections 36 and manual driving recommended sections 38 along the travel route 26 (i.e., if there are no more alterations), then the determination in step 108 is negative and the routine moves to step 112. In step 112, the travel route 26 is displayed on the monitor 18, and travel guidance of the vehicle 10 to the destination G is begun.

As a consequence, in the automated driving recommended sections 36, the vehicle 10 travels in automated driving mode in which the vehicle ECU 20 performs steering control, speed control, and braking control. In the manual driving recommended sections 38, the vehicle 10 travels in either automated driving mode or manual driving mode with switching from the automated driving mode to the manual driving mode, and from the manual driving mode to the automated driving mode being performed by the driving ECU 20.

Here, the display device 28 is provided in the vehicle 10, and when the vehicle 10 is traveling in automated driving mode in an automated driving recommended section 36, the display device 28 displays the previously set video images using the monitor 40.

The processing in the flowchart illustrated in FIG. 6 is executed by the display ECU 30 when the vehicle 10 begins its travel. In the first step 120, whether or not the vehicle 10 is currently traveling in automated driving mode is determined. In a case in which the vehicle 10 is currently traveling in automated driving mode, or in a case in which the vehicle 10 has switched from manual driving mode to automated driving mode, then the determination in step 120 is affirmative and the routine moves to step 122. In step 122, whether or not the vehicle 10 has entered an automated driving recommended section 36 is determined.

In a case in which the vehicle 10 is traveling in manual driving mode, the determination in step 120 is negative, and in a case in which the vehicle is traveling through a manual driving mode recommended section 38, the determination in step 122 is negative. If either one of the determinations in step 120 and step 122 is negative, the routine moves to step 124 and a driving support display is provided using the monitors 40B and 40C.

In this driving support display, when the vehicle external monitoring device 22 detects an object that has a possibility of affecting the travel of its own host vehicle, this object is displayed on the monitor 401 or the monitor 40C such that it is easily visible to the driver D. FIG. 2 illustrated, as an example of a driving support display, a state in which, when a person (i.e., a pedestrian) is in front of the vehicle 10, an instruction display 58 is provided such that the pedestrian is easily visible to the driver D. By displaying the instruction display 58 on the monitor 40B, the alertness of the driver D towards the object is heightened, and the likelihood of the driver r) failing to notice the object when the vehicle 10 has been switched to manual driving mode may be reduced.

In contrast, in a case in which the vehicle 10 enters an automated driving mode recommended section 36 while the vehicle 10 is traveling in automated driving mode, the determinations in each of step 120 and step 122 in the flowchart in FIG. 6 are both affirmative, and the routine moves to step 126. In step 126, the actuator 12C is operated, and the seatback 12A of the seat 12 on which the driver D is sitting is made to recline by being pivoted to the tilted position. Additionally, in step 128, the shutters 48 are operated so that the vehicle cabin interior is light-shielded, and multiple first video images 54A are read in sequence from the storage unit 50, and the first video images 54A are displayed in sequence on the monitor 40 (i.e., the monitors 40A through 40C).

In step 130, whether or not the vehicle 10 is close to a manual driving recommended section 38 is determined. When the vehicle 10 is close to a manual driving recommended section 38, the third video images 54C and the second video images 54B are displayed in sequence using the display device 28. At this time, a display time T1 for the third video images 54C and a display time T2 for the second video images 54B are both set in advance. The display time T2 for the second video images 54B is set so as to enable the driver D, whose alertness had been relaxed as a result of the first video images 54A being displayed, to attain a suitable state of alertness for performing a driving operation of the vehicle 10. A period of, for example, approximately several minutes may be applied as the display time 1′2.

The display time T1 for the third video images 54C is a period that is able to restrict any unnecessary stimulation being imparted to the driver D when switching from the first video images 54A to the second video images 54B, which have mutually opposite visual effects. A period of between, for example, approximately several tens of seconds and a minute may be applied as the display time T1. The state of relaxed alertness of the driver D varies depending on the length of time the first video images 54A are displayed, and it may be thought that the longer the first video images 54A are displayed, the more relaxed the state of alertness of the driver D becomes. Therefore, the display time T2 may be set in accordance with the display time of the first video images 54A and, in this case, the display time T2 of the second video images 54B may be set so as to be correspondingly longer, as the display time of the first video images 54A is made longer.

The display ECU 30 starts the display of the third video images 54C such that the vehicle 10 enters the manual driving recommended section 38 at the timing when the display of the second video images 54B ends. Accordingly, whether or not a predicted time Ts until the vehicle 10 arrives at the manual driving recommended section 38 has reached a display time T (wherein T=T1+T2) may be used to make the determination in step 130.

In a case in which the vehicle 10 has approached close to the manual driving recommended section 38 and the predicted time Ts reaches the display time T (i.e., Ts≤T), the determination in step 130 is affirmative, and the routine moves to step 132. In step 132, the display of the first video images 54A is ended, and the third video images 54B are displayed. After the display of the third video images 54C has ended, the routine moves to step 134, and second video images 54B are displayed.

In step 136, whether or not the vehicle 10 has entered a manual driving recommended section 38 is determined. In a case in which the vehicle has entered a manual driving recommended section 38, the determination in step 136 is affirmative and the routine moves to step 138. In step 138, the seat 12 on which the driver D is sitting is returned to an upright position so as to be in a suitable position for a driving operation, and in step 140, the display of the second video images 54B is ended, and the light-shielding of the vehicle cabin interior by the shutters 48 is deactivated. As a result, the front windshield 44 and each side window glass 46 are placed in a state of transmittance, so that the outside of the vehicle may be viewed from within the vehicle cabin. In the next step 124, the driving support display is begun.

As a result of the above processing, switching of the vehicle 10 from automated driving mode to manual driving mode, and switching of the vehicle 10 from manual driving mode to automated driving mode is performed in the manual driving recommended section 38 because of the road conditions or in response to a request from the driver D. After the vehicle 10 is switched to automated driving mode, a driving operation is performed by the driver D. During the vehicle 10 traveling in manual driving mode in the manual driving recommended sections 38 set by the driver D, the driver D is able to perform the driving operation of the vehicle 10. As a consequence, the driver D is able to enjoy the driving operation of the vehicle 10, and attains a sense of satisfaction.

When the vehicle 10 is traveling in manual driving mode, nervous tension may be forced on the driver D performing the driving operation, and, in particular, driving operations performed on a road where the driving conditions dictate that driving in automated driving mode is difficult may cause the driver D to remain continuously on edge for a prolonged period. This may cause fatigue to accumulate in the driver D.

Therefore, when the vehicle 10 is traveling in automated driving mode through an automated driving recommended section 36, the seat 12 of the vehicle 10 is reclined. As a result, the degree of tension in the driver D may be relaxed.

When the vehicle 10 is traveling in automated driving mode through an automated driving recommended section 36, the display ECU 30 displays the first video images 54A on the monitor 40A of the roof 42, the monitor 40B of the front windshield 44, and the monitors 40C of each side window glass 46. Because of this, the vehicle cabin interior is imbued with the atmosphere of the first video images 54A, and the driver D may feel a realistic sensation of these video images. Note that it is also possible to provide the monitor 40 on other interior surfaces of the vehicle cabin such as door trims and the like so that the screen displaying the video images may be widened even further, and the realistic sensation obtained from the video images may be further heightened.

The first video images 54A are video images in which at least one of the color tone, the motion of the video images, and the objects contained in the video images enables the level of alertness of the driver D to be relaxed, and video images that match the preferences of the driver D are used for the first video images 54A. Because the first video images 54A displayed on the monitor 40 are video images that match the preferences of the driver D, the level of alertness of the driver D may be relaxed, and a recovery in the level of fatigue of the driver D may be achieved.

Moreover, because the color tone of the first video images 54A is blue-based, the vehicle cabin interior is imbued with light having a blue-based color tone. As a result, the level of alertness of the driver D may be relaxed, and a recovery in the level of fatigue of the driver D may be achieved.

Furthermore, because the first video images 54A are video images having a slow motion, a calm sensation may be generated in the driver D who is viewing the first video images 54A. Because of this, the first video images 54A are able to promote a relaxation of the alertness of the driver D viewing these video images, and consequently promote a recovery in their level of fatigue. Moreover, because tension may be removed from the driver D by including smoothly rounded objects in the first video images 54A, the level of alertness of the driver D may be relaxed even further, and their fatigue recovery may be hastened even more quickly.

Moreover, if the same video image is displayed for a prolonged period, the driver D becomes tired of viewing those images, and conversely may experience an increase in fatigue. Multiple first video images 54A are selected in advance, and the display sequence thereof is set, and the display ECU 30 displays the selected first video images 54A on the monitor 40 in their set sequence. Because of this, even if the vehicle 10 travels for a prolonged period in automated driving mode in an automated driving recommended section 36, it is possible to prevent the driver D from becoming tired of viewing the video images, so that any increase in the level of fatigue of the driver D that might occur if the driver D became tired of the first video images 54A may be inhibited.

Accordingly, when the vehicle 10 is traveling in automated driving mode through an automated driving recommended section 36, by displaying the first video images 54A that are able to ease the state of tension of the driver D on the monitor 40, tension in the driver D may be relaxed, and a recovery in the level of fatigue of the drier D may be hastened. Moreover, because video images that match the preferences of the driver D are used for the first video images 54A, it is possible to ease the state of tension and achieve a recovery in the level of fatigue of the driver D even more effectively.

When the vehicle 10 approaches a manual driving recommended section 38, the display ECU 30 displays the second video images 54B on the monitor 40. The second video images 54B are video images in which at least one of the color tone, the motion of the video images, and the objects contained in the video images enables the level of alertness of the driver D to be heightened. Because the color tone of the second video images 54A is red-based, the vehicle cabin interior is imbued with light having a red-based color tone so that a feeling of alertness (i.e., the enthusiasm) may be generated in the driver D, and the level of the alertness of the previously relaxed driver D may be heightened.

Additionally, because the second video images 54B are video images having a rapid motion, a sense of urgency may be generated in the driver D, and the level of the alertness of the previously relaxed driver D may be heightened. Furthermore, because the objects contained in the second video images 54B are jagged picture images, a sense of urgency may be generated in the driver D, and the level of the alertness of the previously relaxed driver D may be heightened.

Because of this, when the vehicle 10 reaches a manual driving recommended section 38, the level of alertness of the driver D may be raised to a suitable state for performing a driving operation of the vehicle 10. As a result, when the vehicle 10 switches from automated driving mode to manual driving mode, the driver D is able to perform a driving operation of the vehicle 10 while being at an appropriate level of alertness for performing this driving operation of the vehicle 10.

Additionally, when the vehicle 10 is traveling in automated driving mode through an automated driving recommended section 36, a recovery in the level of fatigue of the driver D may be achieved. Because of this, it is possible to prevent the driver D from recommencing a driving operation of the vehicle 10 while picture in a fatigued state. As a result, it is possible to prevent the driving operation from being performed sluggishly due to fatigue in the driver D, and the safe travel of the vehicle 10 may be ensured.

Furthermore, when the second video images 54B are displayed after the first video images 54A, the ECU 30 displays the third video images 54C in which at least one of the color tone, the motion of the video images, or the shape of the objects contained in the video images are those of intermediate video images located between the first video images 54A and the second video images 54B. As a consequence of this, because it is possible to prevent the driver D from being overly stimulated by this change in the video images, it is possible to prevent stimulus such as this which is caused by a change in the video images from generating stress in the driver D, and to inhibit any mental fatigue being generated in the driver D as a result of such stress.

Moreover, when the vehicle 10 enters a manual driving recommended section 38, the display on the monitor 40 is stopped and the outside of the vehicle is made visible to occupants of the vehicle cabin interior. As a consequence, because the driver D is able to easily restore the sensation of performing a driving operation prior to the driver D actually driving the vehicle 10, the driver D is able to transition smoothly to manual driving mode, and to smoothly begin to perform a driving operation of the vehicle 10.

In the above-described exemplary embodiment, the third video images 54C are displayed between the first video images 54A and the second video images 54B, however, the present disclosure is not limited to this. It is also possible, for example, for the display of the third video images 54C to be omitted altogether. In this case, the display ECU 30 switches the display by, for example, fading in the second video images 54B while simultaneously fading out the first video images 54A. By doing this, even if the video images displayed on the monitor 40 change from the first video images 54A to the second video images 54B, it is possible to prevent the driver D from being overly stimulated, and a smooth switch in the display from the first video images 54A to the second video images 54B may be achieved.

Moreover, in the present exemplary embodiment, a reclining seat is used as the seat 12 on which the driver D sits, however, the present disclosure is not limited to this. The seat 12 may be formed by a seat that does not recline, and the seat 12 may also, for example, be a seat that slides towards the vehicle rear side. By doing this, the gap between the driver D and the steering wheel 14 (as well as the instrument panel 16) may be increased, so that a feeling of space may be imparted to the driver D, and tension may be alleviated in the driver D.

Moreover, by not using a reclining seat for the seat 12, the monitor 40A provided in the roof 42 may either be omitted or reduced in size. In other words, it is sufficient for the monitor 40B of the front windshield 44 and the monitors 40C of each side window glass 46 to be used as the monitor 40.

Moreover, in the present exemplary embodiment, video images are displayed on the monitor 40 which uses organic EL as the display medium, however, it is also possible in the present disclosure to display video images on a display unit that uses a different display medium from this. Additionally, it is also possible for the display device for a vehicle to be a display unit that displays images by, for example, projecting them by a projector using as the display medium the surface of the ceiling of the vehicle cabin interior, or vehicle cabin interior surfaces such as door trims or the like, or windshield glass or the like that has been light-shielded by light-shielding components such as the shutters 48 or the like.

Moreover, a description is given above of when the setting processing and display processing are both software processing that is performed as a result of programs being executed, however, it is also possible for such processing to be performed by hardware. The setting processing and display processing may also each be performed via a combination of both software and hardware.

The programs that perform the setting processing and display processing of the present exemplary embodiment may each be stored in the memories of the navigation device 24 and the display ECU 30. Alternatively, they may also be stored in another type of storage medium that is provided in the vehicle, or may also be stored on a variety of external storage media so that they are able to be distributed.

In addition to those described above, various other modifications and the like may be made to the present disclosure insofar as they do not depart from the spirit or scope of the present disclosure. It is to be understood that the technological range of the present disclosure is not limited to the above-described exemplary embodiment.

What is claimed is:

1. A display device for a vehicle comprising: a display unit, a memory and a processor coupled to the memory, the processor configured to:
divide a travel route traveled by a vehicle into at least one automated driving recommended section where the vehicle travels in automated driving mode, and at least one manual driving recommended sections where traveling in manual driving mode is urged; and
when a vehicle is traveling in automated driving mode in the at least one automated driving recommended section, display on the display unit at least one first video image that is able to relax a level of alertness of a vehicle occupant when the vehicle occupant views the at least one first video image, and before the vehicle reaches the at least one manual driving recommended section, display on the display unit a second video image that promotes an increased level of alertness in the vehicle occupant when the vehicle occupant views the second video image.

2. The display device for a vehicle according to claim 1, wherein the processor is further configured to set at least one of the at least one first video image or the second video image in accordance with preference information for the vehicle occupant.

3. The display device for a vehicle according to claim 1, further comprising a receiving unit that receives inputs of the at least one manual driving recommended section relating to the travel route,
wherein the processor is further configured to set sections received by the receiving unit as the at least one manual driving recommended section.

4. The display device for a vehicle according to claim 1, wherein the at least one first video images is a video image having a blue-based color tone, and the second video image is a video image having a red-based color tone.

5. The display device for a vehicle according to claim 1, wherein the processor is further configured to display a third video image that is an intermediate video image midway between the at least one first video image and the second video image, on the display unit between the at least one first video image and the second video image.

6. A vehicle comprising the display device for a vehicle according to claim 1.

7. A display control method for a vehicle comprising:
dividing a travel route traveled by a vehicle into at least one automated driving recommended section where the vehicle travels in automated driving mode, and at least one manual driving recommended section where traveling in manual driving mode is urged; and
when a vehicle is traveling in automated driving mode in the at least one automated driving recommended section, displaying on a display unit at least one first video image that is able to relax a level of alertness of a vehicle occupant when the vehicle occupant views the at least one first video image, and before the vehicle reaches the manual driving recommended sections, displaying on the display unit a second video image that promotes an increased level of alertness in the vehicle occupant when the vehicle occupant views the second video image.

8. A non-transitory storage medium storing a program that causes a computer to execute display control processing for a vehicle, the display control processing comprises:
dividing a travel route traveled by a vehicle into at least one automated driving recommended section where the vehicle travels in automated driving mode, and at least one manual driving recommended section where traveling in manual driving mode is urged; and
when a vehicle is traveling in automated driving mode in the at least one automated driving recommended section, displaying on a display unit at least one first video image that is able to relax a level of alertness of a vehicle occupant when the vehicle occupant views the at least one first video image, and before the vehicle reaches the manual driving recommended sections, displaying on the display unit a second video image that promotes an increased level of alertness in the vehicle occupant when the vehicle occupant views the second video image.
